(19) United States
(12) Patent Application Publication
(10) Pub. No.: US 2015/0312090 A1
(43) Pub. Date: Oct. 29, 2015

(54) Relay System and Switching Device

(71) Applicant: Hitachi Metals, Ltd., Tokyo (JP)

(72) Inventors: Makoto YASUDA, Tsuchiura (JP); Shigeru TSUBOTA, Tsuchiura (JP)

(21) Appl. No.: 14/688,030

(22) Filed: Apr. 16, 2015

(30) Foreign Application Priority Data
Apr. 28, 2014 (JP) 2014-093203

(51) Int. Cl. H04L 12/24; H04L 12/741; H04L 12/939

(52) U.S. Cl. CPC H04L 41/0654; H04L 41/0631; H04L 49/557; H04L 45/745

(57) ABSTRACT

When a first port group is set to active and a minimum link determining unit determines that a link fault is absent, a port control unit controls a first port, in which no fault occurrence is detected, in the first port group to a first state. When the first port group is set to standby and a fault notification frame is not received via a bridge port, the port control unit controls the plurality of first ports constituting the first port group to a second state. An OAM transmitting unit transmits a CCM frame from each of the first ports controlled to the first state and transmits a RDI frame from each of the first ports controlled to the second state.

### CROSS-REFERENCE TO RELATED APPLICATION

The present application claims priority from Japanese Patent Application No. 2014-093203 filed on Apr. 28, 2014, the content of which is hereby incorporated by reference into this application.

### TECHNICAL FIELD OF THE INVENTION

The present invention relates to a relay system and a switching device, for example, a relay system to which a device-level redundancy using two switching devices is applied.

### BACKGROUND OF THE INVENTION

Japanese Patent Application Laid-open Publication No. 2011-250185 (Patent Document 1) discloses a network system in which an inter-device link aggregation is set on each link between one network device and two network devices. When a fault occurs on a dedicated line connecting two network devices, an alternative path, is established by using the link aggregation path. Also, two network devices are operated as an active system and a standby system for a control plane such as synchronization of path information between the devices, and are both used in an active state for a data plane.

Japanese Patent Application Laid-Open Publication No. 2012-209984 (Patent Document 2) discloses a configuration in which an inter-device link aggregation is set on each link between a customer edge in a user network and two provider edges in a MPLS network. When both of the two provider edges receive a packet from a different provider edge, only one of the two provider edges relays the packet to the customer edge based on a rule made in advance between the two provider edges.

Japanese Patent Application Laid-Open Publication No. 2012-231223 (Patent Document 3) discloses an access system in which a link is provided each between a user L2 switch and an active L2 switch and between the user L2 switch and a reserve L2 switch. In a normal situation, the reserve L2 switch controls a port serving as a connection source of the link to the user L2 switch to a link-down state. The user L2 switch transmits a broadcast frame such as an ARP to the active L2 switch and the reserve L2 switch, thereby automatically establishing a path bypassing the port controlled to the link-down state in the reserve L2 switch.

### SUMMARY OF THE INVENTION

For example, an active/standby system typified by ESRP (Extreme Standby Router Protocol) and VSRP (Virtual Switch Redundancy Protocol) has been known as a device-level redundancy using layer 2 (hereinafter, abbreviated as “L2”) switching devices which carry out the L2 processes. In such a system, when a fault occurs on a link, between a user L2 switching device and an active L2 switching device, the user L2 switching device usually flushes a FDB (Forwarding DataBase) in order to switch the path to a link between the user L2 switching device and a standby L2 switching device. This may lead to communication congestion or the like due to flooding.

For the solution of such a problem, for example, the system using inter-device link aggregation group (hereinafter, abbreviated as “LAG”) as described in the Patent Document 1 and the Patent Document 2 is considered. In this case, since the user L2 switching device virtually manages ports, on which the LAG is set, as a single port on the FDB, it is not necessary to perform the flushing of the FDB when a fault occurs.

Here, a case in which two L2 switching devices (A and B) to which an inter-device LAG is applied are provided, and one of the two devices (A) is used in an active state and the other (B) is used in a standby state is assumed. Although the user switching device is connected to each of the two L2 switching devices (A and B) via an inter-device communication line, the user switching device communicates with only the L2 switching device (A) when fault is absent.

In this case, however, since the communication band is restricted based on the communication line between the user switching device and the L2 switching device (A), the communication band cannot be improved in some cases. For the solution thereof, it is proposed to employ the system in which the two L2 switching devices (A and B) are both used in an active state. In this case, however, since the frame transfer paths are distributed to the two L2 switching devices (A and B), it becomes difficult to grasp the frame transfer paths. In particular, a communication carrier, etc. have a desire to implement detailed network management including frame transfer paths in some cases.

Thus, it is beneficial to use the two L2 switching devices (A and B) in active/standby states and to connect the user switching device and each, of two L2 switching devices (A and B) with a plurality of communication lines. In this manner, it becomes possible to facilitate the network management while securing the sufficient communication band. In this case, however, since a plurality of communication lines are used, some measures to efficiently improve the availability at the time of occurrence of the fault are necessary. Namely, since it is possible to improve the availability by the plurality of communication lines and also by the device-level redundancy, it is necessary to use them efficiently and make the user switching device perform the operation in accordance with their use.

The present invention has been made in view of the problem above, and an object thereof is to provide a relay system and a switching device using a device-level redundancy capable of efficiently improving the availability.

The above and other objects and novel characteristics of the present invention will be apparent from the description of the present specification and the accompanying drawings.

The following is a brief description of an outline of the typical embodiment of the invention disclosed in the present application.

A relay system according to the present embodiment includes: first and second switching devices and a third switching device. The first switching device and the second switching device each have a first port group made up of a plurality of first ports and a bridge port, and the first switching device and the second switching device are connected to each other by a communication line via the bridge ports. The third switching device is connected to the plurality of first ports of the first switching device and the plurality of first ports of the second switching device via different communication lines, and the third switching device sets a link aggregation group on ports serving as connection sources of the communication lines. The first port group of the first switching device is set to active and the first port group of the second switching device is set to standby. Here, each of the first switching device and the second switching device includes: a fault monitoring unit; a minimum link transmitting unit; a fault frame transmitting unit; a port control unit; and an OAM transmitting unit. The fault monitoring unit detects a fault occurrence at the plurality of first ports. The minimum link determining unit determines that a link fault is absent when the number of the first ports, in which no fault occurrence is detected by the fault monitoring unit, in the first port group is equal, to or larger than a predetermined set number, and determines that a link fault is present when the number is smaller than the set number. The fault frame transmitting unit transmits a fault notification frame via the bridge port when the minimum link determining unit determines that the link fault is present. (A) In a first case in which the first port group is set to the active and when the minimum link determining unit determines that the link fault is absent, the port control unit controls the first port, in which no fault occurrence is detected by the fault monitoring unit, in the first port group to a first state in which transmission and reception are both permitted. (B) In the first-case and when the minimum link determining unit determines that the link fault is present, the port control unit controls the plurality of first ports constituting the first port group to a second state in which transmission and reception are both prohibited. (C) In a second case in which the first port group is set to the standby and when the fault notification frame is not received via the bridge port, the port control unit controls the plurality of first ports constituting the first port group to the second state. (D) In the second case and when the fault notification frame is received via the bridge port, the port control unit controls the first port, in which no fault occurrence is detected by the fault monitoring unit, in the first port group to the first state. The OAM transmitting unit transmits a COM frame based on Ethernet OAM from each of the first ports controlled to the first state, and transmits a ROT frame based on Ethernet OAM from each of the first ports controlled to the second state.

The effects obtained by typical embodiments of the invention disclosed in the present application will be briefly described below. That is, in a relay system and a switching device using a device-level redundancy, the availability can be efficiently improved.

### BRIEF DESCRIPTIONS OF THE DRAWINGS

FIG. 1 is a schematic diagram of a configuration example of a relay system according to an embodiment of the present invention;

FIG. 2 is an explanatory diagram schematically showing an operation example in the absence of fault in the relay system of FIG. 1;

FIG. 3 is an explanatory diagram schematically showing an operation example in the case in which a fault occurs at a MCLAG port and the minimum link number is satisfied in the relay system of FIG. 1;

FIG. 4 is an explanatory diagram schematically showing an operation example in the case in which a fault occurs at a MCLAG port and the minimum link number is not satisfied in the relay system of FIG. 1;

FIG. 5 is an explanatory diagram schematically showing an operation example in the case of recovery from fault at a MCLAG port in the relay system of FIG. 1;

FIG. 6 is a block diagram of a configuration example of the principle part of the L2 switching device constituting the MCLAG device in the relay system of FIG. 1;

FIG, 7A is a schematic diagram of a configuration example of an address table of FIG. 6;

FIG. 7B is a schematic diagram of a configuration example of a fault monitoring table of FIG. 6;

FIG. 7C is a schematic diagram of a configuration example of a port control table of FIG. 6;

FIG. 8 is a flowchart schematically showing an example of process contents carried out by the port control unit of the L2 switching device of FIG. 6 when the L2 switching device is set to active;

FIG. 9 is a flowchart schematically showing an example of process contents carried out by the port control unit, of the L2 switching device of FIG. 6 when the L2 switching device is set to standby;

FIG. 10 is a flowchart schematically showing an example of process contents carried out by the relay processing unit of the L2 switching device of FIG. 6; and

FIG. 11 is a block diagram schematically showing a configuration example of the user L2 switching device in the relay system of FIG. 1.

### DESCRIPTIONS OF THE PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited, to a specific number in principle, and the number larger or smaller than the specified number is also applicable.

Further, in the. embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included, therein unless otherwise stated or except the case where it is conceivable that they are apparently excluded in principle. The same goes for the numerical value and the range described above.

Hereinafter, embodiments of the present invention will be. described in detail with reference to the accompanying drawings. Note that components having the same function are denoted by the same reference characters throughout the drawings for describing the embodiments, and the repetitive description thereof will be omitted.

### General Configuration of Relay System

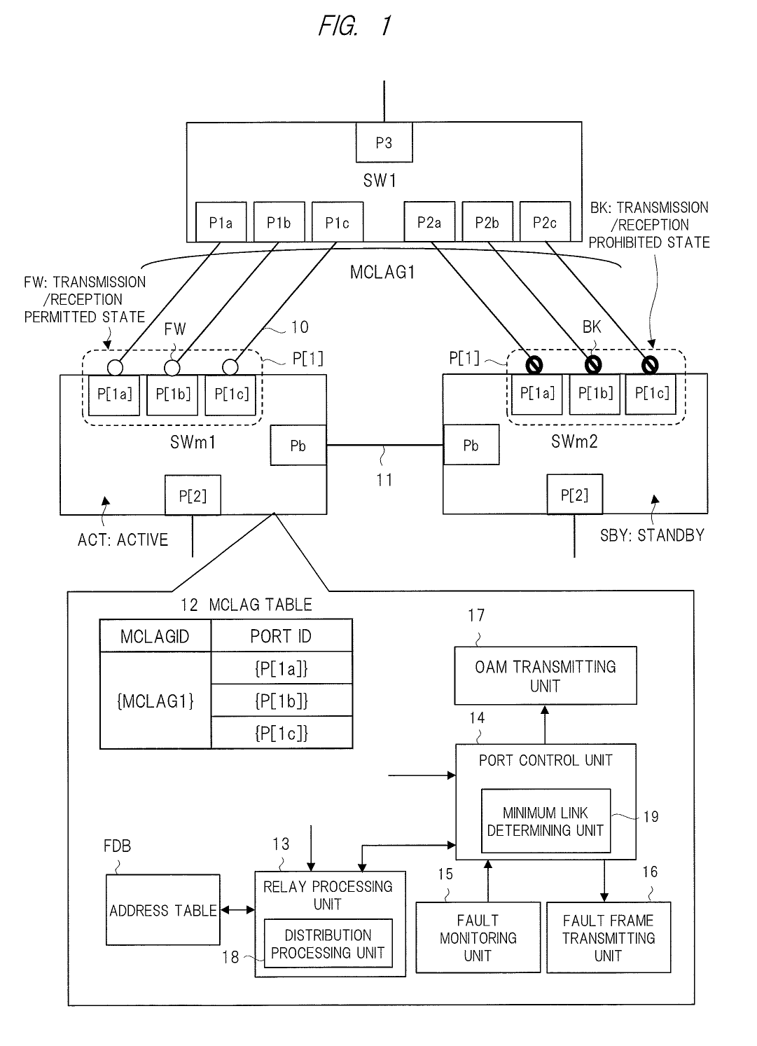

FIG. 1 is a schematic diagram of a configuration example of a relay system according to an embodiment of the present invention. The relay system of FIG. 1 includes two L2 switching devices (first and second switching devices) SWm1 and SWm2 to which an inter-device LAG is applied and a user L2 switching device (third switching device) SW1. Each of the L2 switching devices SWm1 and SWm2 has a MCLAG port group (first port group) P[1], a port (second port) P[2] and a bridge port Pb.

The MCLAG port group (first port group) P[1] is made up of a plurality of (in this case, three) MCLAG ports (first ports) P[1a], P[1b] and P[1c]. The L2 switching device (first switching device) SWm1 and the L2 switching device (second switching device) SWm2 are connected through a communication line 11 via the bridge ports Pb. The communication line 11 is provided as, for example, a dedicated line or sometimes provided as an ordinary communication line (for example, Ethernet (registered trademark) line). Though not particularly limited, a terminal, etc. are connected to the ports P2 of the L2 switching devices SWm1 and SWm2.

The L2 switching device (third switching device) SW1 has a plurality of (in this case, six) LAG ports P1a, P1b, P1c, P2a, P2b and P2c and one port P3. The L2 switching device SW1 is connected, to the plurality of MCLAG ports (first ports) P[1a], P[1b] and P[1c] of the L2 switching device SWm1 and to the plurality of MCLAG ports (first ports) P[1a], P[1b] and P[1c] of the L2 switching device SWm2 by respectively different communication lines 10.

In this example, the LAG ports P1a, P1b and P1c are connected to the MCLAG ports P[1a], P[1b] and P[1c] of the L2 switching device SWm1, respectively. Also, the LAG ports P2a, P2b and P2c are connected to the MCLAG ports P[1a], P[1b] and P[1c] of the L2 switching device SWm2, respectively. Also, though not particularly limited, a terminal, etc. are connected to the port P3. The communication lines 10 are formed by, for example, Ethernet lines. Here, the L2 switching device (third switching device) SW1 sets the LAG on the ports (LAG ports) P1a, P1b, P1c, P2a, P2b and P2c serving as connection sources of the communication lines 10 between the L2 switching device SW1 and the L2 switching devices SWm1 and SWm2.

The LAG is generally applied to a plurality of communication lines between one device and another device in many cases. In this example, however, the LAG is applied to a plurality of communication lines between one device and two devices. In this specification, therefore, such an inter-device LAG is distinguished from an ordinary LAG and is referred to as multi-chassis link aggregation group (hereinafter, abbreviated as MCLAG). The L2 switching device SW1 thus sets a MCLAG1 on the LAG ports P1a, P1b, P1c, P2a, P2b and P2c.

Also, in this specification, the two L2 switching devices SWm1 and SWm2, to which such an inter-device LAG is applied, are collectively referred to as MCLAG devices. The L2 switching device SW1 is operated while regarding the MCLAG devices as virtually one device. Therefore, in practice, the L2 switching device SW1 handles the ports on which the MCLAG1 is set (P1a, P1b, P1c, P2a, P2b and P2c) as LAG ports without distinguishing the MCLAG and the LAG.

In this example, the MCLAG port group P[1] of each of the L2 switching devices SWm1 and SWm2 is made up of three MCLAG ports, but the number of MCLAG ports is not limited to this and may be two or more. Also, according to the circumstances, the number of MCLAG ports constituting the MCLAG port group may be different between the L2 switching device SWm1 and the L2 switching device SWm2.

Furthermore, two or more MCLAGs may be set instead of one MCLAG. For example, when a user L2 switching device is connected also to the ports P[2] of the L2 switching devices SWm1 and SWm2, the user L2 switching device can set another MCLAG (for example, MCLAG2) to the ports serving as connection sources thereof. In this case, the ports P[2] may be MCLAG port groups made up of a plurality of MCLAG ports (for example, P[2a], P[2b], . . . ) like the case of the MCLAG1.

Each of the L2 switching devices (first and second switching devices) SWm1 and SWm2 has a MCLAG table 12, a relay processing unit 13, an address table FDB, a port control unit 14, a fault monitoring unit 15, a fault frame transmitting unit 16 and an OAM transmitting unit 17. The relay processing unit 13 has a distribution processing unit 18 and the port control unit 14 has a minimum link determining unit 19.

The MCLAG table 12 retains the plurality of MCLAG ports (actually, port identifiers thereof) of its own switching device in association with MCLAG identifiers. In the example of FIG. 1, the MCLAG table 12 retains the plurality of MCLAG ports (first ports) P[1a], P[1b], P[1c] (port identifiers {P[1a]}, {P[1b]} and {P[1c]} thereof) in association with the MCLAG port identifier (first identifier) {MCLAG1}. In this specification, for example, {AA} represents an identifier (ID) for “AA”.

For example, it is determined in advance that MCLAG devices commonly use the MCLAG identifier {MCLAG1}. Each L2 switching device constituting the MCLAG device determines port identifiers {P[1a]}, {P[1b]} and {P[1c]} of its own MCLAG ports to be assigned to a MCLAG identifier {MCLAG1} based on its own MCLAG table 12.

The fault monitoring unit 15 detects fault occurrence at the plurality of ports of its own switching device (MCLAG ports P[1a], P[1b] and P[1c], port P[2] and bridge port Pb). Specifically, the fault monitoring unit 15 detects the fault occurrence by recognizing, for example, reduction of signal intensity of a received signal, non-detection of a pulse signal such as FLP (Fast Link Pulse), or non-reception of a CCM control frame described later. The minimum link determining unit 19 determines that a link fault is absent when the number of MCLAG ports (first ports), in which no fault occurrence is detected by the fault monitoring unit 15, in the MCLAG port group (first port group) is equal to or larger than a predetermined set number (hereinafter, referred to as minimum link number) and determines that a link fault is present when the number is smaller than the minimum link number.

For example, the case in which the minimum link number is 2 is assumed. The minimum link determining unit 19 determines that a link fault is absent when the fault occurrence at one MCLAG port in the three MCLAG ports (first ports) P[1a], P[1b] and P[1c] constituting the MCLAG port group P[1] is detected by the fault monitoring unit 15. On the other hand, the minimum link determining unit 19 determines that, a link fault is present when the fault-occurrence at two or more MCLAG ports in the three MCLAG ports (first ports) P[1a], P[1b] and P[1c] is detected by the fault monitoring unit 15.

The fault frame transmitting unit 16 transmits a fault notification frame via the bridge port Pb when the minimum link determining unit 19 determines that a link fault is present. Also, the fault frame transmitting unit 16 transmits a fault recovery frame via the bridge port Pb when the determination result by the minimum link determining unit 19 is changed from the presence of link fault, to the absence of link fault.

The port, control unit 14 performs the following processes (1) and (2).

(1) When the MCLAG port group (first, port, group) P[1] is set to active ACT (first case) and the minimum link determining unit 19 determines that a link fault is absent, the port control unit 14 controls the MCLAG port group (first port group) P[1] to a transmission/reception, permitted state (first state) FW in which transmission and reception are both permitted. In more detail, the port control unit 14 controls the MCLAG ports (first ports), in which no fault occurrence is detected by the fault monitoring unit 15, in the MCLAG port group P[1] to the transmission/reception permitted state FW.

Meanwhile, in the first case mentioned above and when the minimum link determining unit 19 determines that a link fault is present, the port control unit 14 controls the MCLAG port group (first port group) P[1] to a transmission/reception prohibited state (second state) BK in which transmission and reception are both prohibited. In more detail, the port control unit 14 controls the plurality of MCLAG ports (first ports) constituting the MCLAG port group P[1] to the transmission/reception prohibited, state BK.

(2) When the MCLAG port group (first port group) P[1] is set to standby SBY (second case) and the fault notification frame is not received via the bridge port Pb, the port control unit 14 controls the MCLAG port group P[1] to a transmission/reception prohibited state (second state) BK. In more detail, the port control unit 14 controls the plurality of MCLAG ports (first ports) constituting the MCLAG port group P[1] to the transmission/reception prohibited state BK.

Meanwhile, in the second case mentioned above and when the fault notification frame is received via the bridge port Pb, the port control unit 14 controls the MCLAG port group (first port group) P[1] to the transmission/reception permitted state (first state) FW. In more detail, the port control unit 14 controls the MCLAG ports (first ports), in which no fault occurrence is detected by the fault monitoring unit 15, in the MCLAG port group P[1] to the transmission/reception permitted state FW.

Note that the transmission/reception permitted state FW and the transmission/reception prohibited state BK are intended for the user frame serving as a normal frame and are not intended for the control frame for managing and controlling the device typified by the fault notification frame and CCM control frame described above.

In this embodiment, as shown in FIG. 1, one of the two L2 switching devices SWm1 and SWm2 constituting the MCLAG devices (SWm1 in this example) is set to active ACT in units of device in advance, and the other (SWm2 in this example) is set to standby SBY in units of device in advance. The L2 switching device SWm1 set to active ACT sets its own MCLAG port group P[1] to active ACT, and the L2 switching device SWm2 set to standby SBY sets its own MCLAG port group P[1] to standby SBY.

In the absence of fault, since the MCLAG port group P[1] of the L2 switching device SWm1 is set to active ACT, the port control unit 14 of the L2 switching device SWm1 controls the plurality of MCLAG ports P[1a], P[1b] and P[1c] constituting the MCLAG port group P[1] to the transmission/reception permitted, state FW. On the other hand, since the MCLAG port group P[1] of the L2 switching device SWm2 is set to standby SBY, the port control unit 14 of the L2 switching device SWm2 controls the plurality of MCLAG ports P[1a], P[1b] and P[1c] constituting the MCLAG port group P[1] to the transmission/reception prohibited state BK.

Note that the setting method to active ACT or standby SBY is not necessarily the setting method in units of device, but may be a setting method in units of MCLAG port group. For example, when the ports P[2] of the L2 switching devices SWm1 and SWm2 are also the MCLAG port groups, one of the MCLAG port groups P[1] is set to active ACT and the other is set to standby SBY, and. one of the MCLAG port groups P[2] is set to active ACT and the other is set to standby SBY.

When the MCLAG port group (first port group) P[1] of its own switching device is controlled to the transmission/reception permitted, state FW, the relay processing unit 13 relays a frame containing a MCLAG identifier (first identifier) (MCLAG1) thereof as a destination port to any of the MCLAG ports in the plurality of MCLAG ports (first ports) P[1a], P[1b] and P[1c] of its own switching device . In other words, when the MCLAG ports (first ports) controlled to the transmission/reception permitted state FW are present in the MCLAG port group P[1], the relay processing unit 13 relays a frame to any of the MCLAG ports. At this time, the distribution processing unit 18 determines which MCLAG port the frame is relayed to.

Meanwhile, when the MCLAG port group (first port group) P[1] of its own switching device is controlled to the transmission/reception prohibited state BK, the relay processing unit 13 relays a frame containing a MCLAG identifier (first identifier) {MCLAG1} thereof as a destination port to the bridge port Pb. In other words, when the MCLAG port (first port) controlled to the transmission/reception permitted state FW is not. present in the MCLAG port group P[1], the relay processing unit 13 relays a frame to the bridge port Pb.

In this case, the frame destination port is determined based on the retrieval result on the address table FDB. It is widely known that the address table FDB retains the correspondence relation between a port and a MAC (Media Access Control) address present ahead of the port. The relay processing unit 13 carries out, for example, the following process for the address table FDB.

First, when a port having received a frame is the MCLAG port group P[1] (that is, MCLAG ports P[1a], P[1b] and P[1c]) of its own switching device, the relay processing unit 13 determines the MCLAG identifier {MCLAG1} corresponding to the MCLAG port group to be a reception port identifier. The relay processing unit. 13 then learns a source MAC address contained in the frame in association with the reception port identifier to the address table FDB. Also, the relay-processing unit 13 retrieves the destination port corresponding to the destination MAC address contained in the frame from, the address table FDB.

When the frame received at the MCLAG port group is relayed to the bridge port Pb based on the retrieval result of the address table FDB or the like, the relay processing unit 13 relays the frame, to which the reception port identifier is added, to the bridge port Pb. The case in which the frame is relayed to the bridge port Pb corresponds to the case in which the bridge port Pb is acquired as a destination port or the case in which the MCLAG identifier is acquired as a destination port and the MCLAG port group of its own switching device corresponding to the MCLAG identifier is controlled to the transmission/reception prohibited state BK (namely, the case in which no MCLAG port controlled to the transmission/reception permitted state FW is present).

When the frame to which a reception port identifier is added is received at the bridge port Pb, the relay processing unit 13 learns a source MAC address contained in the frame in association with the reception port identifier added to the frame to the address table FDB. On the other hand, when the frame to which a reception port identifier is not added is received at the bridge port Pb, the relay processing unit 13 learns a source MAC address contained in the frame in association with the port identifier {Pb} of the bridge port Pb to the address table FDB.

The OAM transmitting unit 17 transmits a control frame based on the Ethernet OAM (Operations, Administration and Maintenance). The Ethernet OAM has been standardized by “ITU-T Y.1731” and “IEEE802.1ag”, etc. as the maintenance and management function. In the Ethernet OAM, a function referred to as CC (Continuity Check) is defined as one of its functions. This is a function of monitoring continuity between monitoring points called MEP (Maintenance End Point) by transmitting and receiving a control frame called CCM (Continuity Check Message) (hereinafter, referred to as CCM control frame) between the monitoring points.

For example, the L2 switching device SWm1 and the L2 switching device SW1 both set the MCLAG port P[1a] of the L2 switching device SWm1 and the LAG port P1a of the L2 switching device SW1 as MEP (defined as MEP1a), and transmit and receive the CCM control frame between the MEP1a at regular intervals. Similarly, the L2 switching device SWm1 and the L2 switching device SW1 both set the MCLAG port P[1b] and the LAG port P1b as MEP1b and set the MCLAG port P[1c] and the LAG port P1c as MEP1c, and transmit and receive the CCM control frame between the MEP1b and between MEP1c at regular intervals.

Here, for example, when the L2 switching device SWm1 cannot receive the CCM control frame at the MCLAG port P[1a] from the LAG port P1a of the L2 switching device SW1 within a predetermined period, the L2 switching device SWm1 determines that the continuity with respect to the LAG port P1a is in a LOC (Loss Of Continuity) state. In this case, the L2 switching device SWm1 transmits the CCM control frame having a flag attached to a RDI (Remote Defect Indication) bit when transmitting the CCM control frame from the MCLAG port P[1a] to the LAG port P1a of the L2 switching device SW1.

In this specification, the CCM control frame having no flag attached to the RDI bit is simply referred to as CCM frame (abbreviated as CCM), and the CCM control frame having a flag attached to the RDI bit is referred to as RDI frame (abbreviated as RDI). Upon reception of the RDI at the LAG port P1a, the L2 switching device SW1 recognizes that a fault is present in a transmission path from the LAG port P1a, and stops the transmission of the frame (user frame) from the LAG port P1a until the RDI is canceled (namely, until being able to receive the CCM). Specifically, when selecting the transmission port from the member ports (P1a to P1c and P2a to P2c) of the MCLAG1, the L2 switching device SW1 eliminates the LAG port P1a from the choices of the transmission port.

By using the mechanism of the Ethernet OAM like this, the OAM transmitting unit 17 transmits the CCM from each of the MCLAG ports (first ports) P[1a], P[1b] and P[1c], in which no fault occurrence is detected by the fault monitoring unit 15, in the MCLAG port group (first port group) P[1] controlled to the transmission/reception permitted state (first state) FW. Also, the OAM transmitting unit 17 transmits the RDI from, each of the plurality of MCLAG ports (first ports) P[1a], P[1b] and P[1c] constituting the MCLAG port group (first port group) P[1] controlled to the transmission/reception prohibited state (second state) BK.

### General Operation of Relay System (in the Absence of Fault)

FIG, 2 is an explanatory diagram, schematically showing an operation example in the absence of fault in the relay system of FIG, 1. In this example, a frame is transmitted and received between a terminal connected to the port P3 of the user L2 switching device SW1 and a terminal connected to the ports P[2] of the MCLAG devices (SWm1 and SWm2).

Since the MCLAG port group P[1] is set to active ACT and the minimum link determining unit 19 determines that a link fault is absent, the port control unit 14 of the L2 switching device SWm1 controls the MCLAG ports P[1a], P[1b] and P[1c], in which no fault occurrence is detected by the fault monitoring unit 15, to the transmission/reception permitted state FW. On the other hand, since the MCLAG port group P[1] is set to standby SBY and the fault notification frame is not received via the bridge port Pb, the port control unit 14 of the L2 switching device SWm2 controls the plurality of MCLAG ports P[1a], P[1b] and P[1c] to the transmission/reception prohibited state BK.

The OAM transmitting unit 17 of the L2 switching device SWm1 transmits the CCM at regular intervals from each of the MCLAG ports P[1a], P[1b] and P[1c] controlled to the transmission/reception permitted state FW. Since the user L2 switching device SW1 receives the CCM at regular intervals at each of the LAG ports P1a, P1b and P1c, it transmits the CCM at regular intervals from each of the LAG ports P1a, P1b and P1c.

On the other hand, the OAM transmitting unit 17 of the L2 switching device SWm2 transmits the RDI from each of the plurality of MCLAG ports P[1a], P[1b] and P[1c] controlled to the transmission/reception prohibited state BK. Since the L2 switching device SW1 receives the RDI at each of the LAG ports P2a, P2b and P2c, it transmits the CCM from each of the LAG ports P2a, P2b and P2c.

As a result, the L2 switching device SWm2 receives the CCM at each of the MCLAG ports P[1a], P[1b] and P[1c]. Although the L2 switching device SWm2 receives the CCM like this, it transmits the RDI from each of the MCLAG ports P[1a], P[1b] and P[1c] at regular intervals, and the L2 switching device SW1 which has received the RDI transmits the CCM at regular intervals from each of the LAG ports P2a, P2b and P2c. In this manner, the user L2 switching device SW1 eliminates the LAG ports P2a, P2b and P2c from the choices of the transmission port to the MCLAG1 at least at the time of frame transmission.

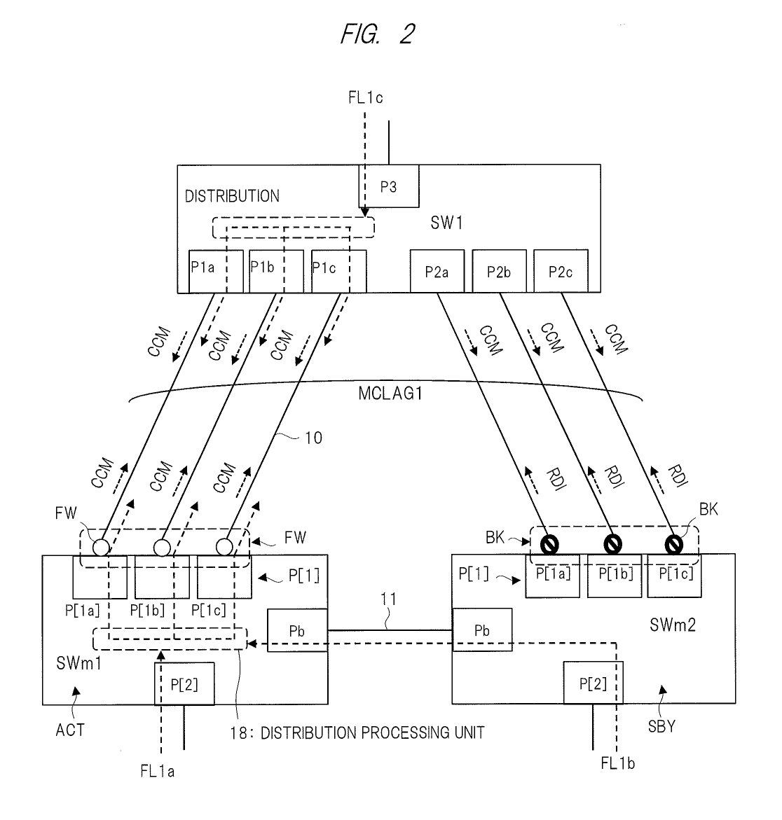

In this situation, first, the case in which the L2 switching device SWm1 receives a frame FL1a at the port P[2] as shown in FIG. 2 is assumed. The L2 switching device SWm1 learns a source MAC address of the frame FL1a in association with the port identifier {P[2]} serving as a reception port identifier to the address table FDB. Also, the L2 switching device SWm1 retrieves a destination port corresponding to a destination MAC address of the frame FL1a from the address table FDB. As the retrieval result of the destination port, the L2 switching device SWm1 acquires the MCLAG identifier {MCLAG1}.

Since its own MCLAG port group P[1] corresponding to the MCLAG identifier {MCLAG1} is controlled to the transmission/reception permitted state FW, the L2 switching device SWm1 relays the frame FL1a to the MCLAG port group P[1]. In other words, since the MCLAG ports P[1a], P[1b] and P[1c] controlled to the transmission/reception permitted state FW are present in the MCLAG port group P[1], the L2 switching device SWm1 relays the frame FL1a to the MCLAG port group P[1].

At this time, the distribution processing unit 18 of the L2 switching device SWm1 selects any one MCLAG port from the MCLAG ports P[1a], P[1b] and P[1c] controlled to the transmission/reception permitted state FW based on a predetermined distribution rule. The L2 switching device SWm1 relays the frame FL1a to the selected MCLAG port (for example, P[1a]). The user L2 switching device SW1 receives the frame FL1a at the predetermined LAG port (for example, P1a) and relays it to the port P3.

Next, the case in which the L2 switching device SWm2 receives a frame FL1b at the port P[2] is assumed. The L2 switching device SWm2 learns the source MAC address of the frame FL1b in association with the port identifier {P[2]} serving as a reception port identifier to the address table FDB. Also, the L2 switching device SWm2 retrieves a destination port corresponding to a destination MAC address of the frame FL1b from the address table FOB. As the retrieval result of the destination port, the L2 switching device SWm2 acquires the MCLAG identifier {MCLAG1}.

Since its own MCLAG port group P[1] corresponding to the MCLAG identifier {MCLAG1} is controlled to the transmission/reception prohibited state BK, the L2 switching device SWm2 relays the frame FL1b to the bridge port Pb. In other words, since the MCLAG port controlled to the transmission/reception permitted state FW is not present in the MCLAG port group P[1], the L2 switching device SWm2 relays the frame FL1b to the bridge port Pb.

The L2 switching device SWm1 receives the frame FL1b at the bridge port Pb and learns the source MAC address thereof in association with the port identifier {Pb} serving as a reception port identifier to the address table FDB. Also, the L2 switching device SWm1 retrieves a destination port corresponding to a destination MAC address of the frame FL1b from the address table FDB. As the retrieval result of the destination port, the L2 switching device SWm1 acquires the MCLAG identifier {MCLAG1},

Since its own MCLAG port group P[1] corresponding to the MCLAG identifier {MCLAG1} is controlled to the transmission/reception permitted state FW, the L2 switching device SWm1 selects one MCLAG port based on the predetermined distribution rule like the case of the frame FL1a and relays the frame FL1b to the selected MCLAG port (for example, P[1b]). The user L2 switching device SW1 receives the frame FL1b at a predetermined LAG port (for example, P1b) and relays it to the port P3.

Subsequently, the case in which the user L2 switching device SW1 receives the frame FL1c at the port P3 is assumed. The L2 switching device SW1 performs the learning and retrieval on the address table FDB like the case of the MCLAG device. As a result of the retrieval on the address table, the L2 switching device SW1 acquires the LAG identifier corresponding to the MCLAG1 as a destination port corresponding to the destination MAC address of the frame FL1c. The L2 switching device SW1 selects one LAG port based on the predetermined distribution rule from the LAG ports P1a, P1b and P1c serving as choices of the transmission port to the MCLAG1 and relays the frame FL1c to the selected LAG port (for example, P1c).

The L2 switching device SWm1 receives the frame FL1c at a predetermined MCLAG port (for example, P[1c]) and learns the source MAC address thereof in association with the MCLAG identifier {MCLAG1} serving as a reception port identifier to the address table FDB. Also, the L2 switching device SWm1 retrieves a destination port corresponding to a destination MAC address of the frame FL1c from the address table FDB. Here, when the terminal corresponding to the destination MAC address is present ahead of the port P[2] of the L2 switching device SWm1, the port identifier {P[2]} is acquired as the destination port, and when it is present ahead of the port P[2] of the L2 switching device SWm2, the port identifier {Pb} is acquired as the destination port.

When the port identifier {P[2]} is acquired as the destination port, the L2 switching device SWm1 relays the frame FL1c to the port P[2]. Meanwhile, when the port identifier {Pb} is acquired as the destination port, the L2 switching device SWm1 adds the reception port identifier {MCLAG 1} to the frame FL1c and then relays the frame FL1c to the bridge port Pb.

The L2 switching device SWm2 receives the frame FL1c, to which the reception port identifier {MCLAG1} is added, at the bridge port Pb, and learns the source MAC address thereof in association with the reception port identifier {MCLAG1} to the address table FDB. Also, the L2 switching device SWm2 retrieves the destination port corresponding to the destination MAC address of the frame FL1c from the address table FDB. As a result, the L2 switching device SWm2 relays the frame FL1c to the port P[2] acquired as the destination port.

### General Operation of Relay System (in the Occurrence of Fault at MCLAG Port[1])

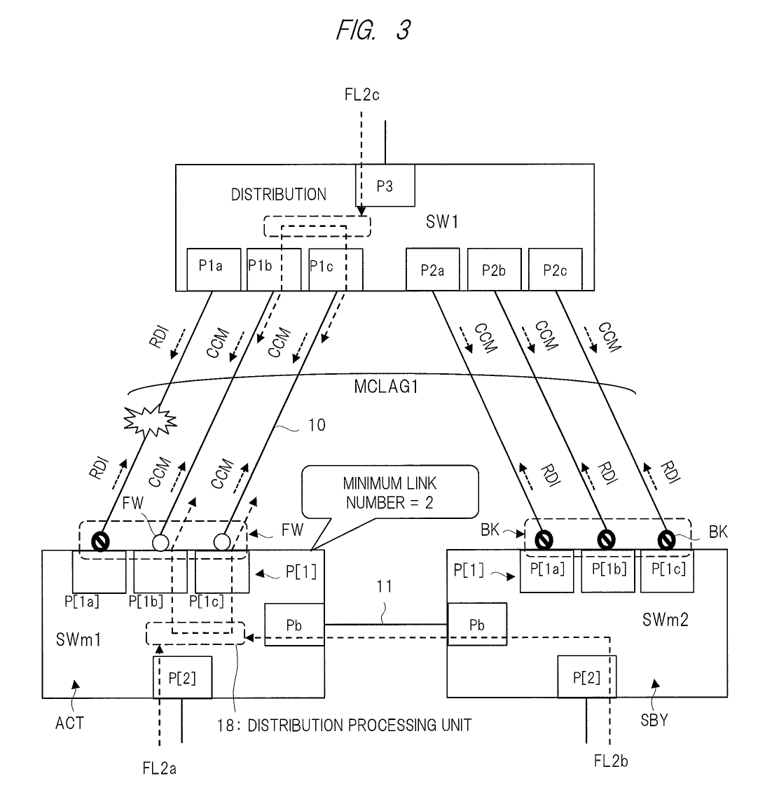

FIG. 3 is an explanatory diagram schematically showing an operation example in the case in which a fault occurs at a MCLAG port and the minimum link number is satisfied in the relay system of FIG. 1. Here, the case in which, a fault occurs on the communication line 10 connected to the MCLAG port P[1a] of the L2 switching device SWm1 in the state of the absence of fault shown in FIG. 2 is taken as an example. Also, the minimum link number is set to 2 in this case.

The fault monitoring unit 15 of the L2 switching device SWm1 detects a fault occurrence at the MCLAG port P[1a]. Since the number of MCLAG ports (P[1b] and P[1c]) in which no fault occurrence is detected by the fault monitoring unit 15 in the MCLAG port group P[1] is equal to or larger than the minimum link number (=2), the minimum link determining unit 19 of the L2 switching device SWm1 determines that a link fault is absent.

Since it is determined that the link fault is absent, the port control unit 14 of the L2 switching device SWm1 controls the MCLAG ports P[1b] and P[1c], in which no fault occurrence is detected by the fault monitoring unit 15, to the transmission/reception permitted state FW. Also, the port control unit 14 of the L2 switching device SWm1 controls the MCLAG port P[1a], in which the fault occurrence is detected by the fault monitoring unit 15, to the transmission/reception prohibited state BK. Meanwhile, the port control unit 14 of the L2 switching device SWm2 controls the plurality of MCLAG ports P[1a], P[1b] and P[1c] to the transmission/reception prohibited state BK like the case of FIG. 2.

The OAM transmitting unit 17 of the L2 switching device SWm2 transmits the RDI at regular intervals from each of the MCLAG ports P[1a], P[1b] and P[1c] controlled to the transmission/reception prohibited state BK like the case of FIG. 2. The user L2 switching device SW1 also transmits the CCM at regular intervals from each of the LAG ports P2a, P2b and P2c like the case of FIG. 2.

On the other hand, the OAM transmitting unit 17 of the L2 switching device SWm1 transmits the CCM at regular intervals from each of the MCLAG ports P[1b] and P[1c] controlled to the transmission/reception permitted state FW. Since the user L2 switching device SW1 receives the CCM at regular intervals at each of the LAG ports P1b and P1c, it transmits the CCM at regular intervals from each of the LAG ports P1b and P1c.

Also, since the CCM control frame is not received at the MCLAG port P[1a] due to the fault occurrence, the OAM transmitting unit 17 of the L2 switching device SWm1 transmits the RDI from the MCLAG port P[1a]. Similarly, since the CCM control frame is not received at the LAG port P1a due to the fault occurrence, the user L2 switching device SW1 also transmits the RDI from the LAG port P1a. As a result, the user L2 switching device SW1 eliminates the LAG port P1a from the choices of the transmission port to the MCLAG1 in addition to the LAG ports P2a, P2b and P2c described with reference to FIG. 2.

In this situation, the case in which the L2 switching device SWm1 receives a frame FL2a at the port P[2] and the L2 switching device SWm2 receives a frame FL2b at the port P[2] like the case of FIG. 2 is assumed. In this case, the frames FL2a and FL2b are transferred through substantially the same paths as those of the frames FL1a and FL1b shown in FIG. 2. As shown in FIG. 3, however, when relaying the frames FL2a and FL2b to the MCLAG port group P[1], the L2 switching device SWm1 selects one MCLAG port from the two MCLAG ports P[1b] and P[1c] controlled to the transmission/reception permitted state FW unlike the case of the frames FL1a and FL1b.

Next, the case in which the user L2 switching device SW1 receives a frame FL2c at the port P3 like the case of FIG. 2 is assumed. Also in this case, the frame FL2c is transferred through substantially the same path as that of the frame FL1c shown in FIG. 2. As shown in FIG. 3, however, when relaying the frame FL2c to the LAG port, the L2 switching device SW1 selects one LAG port from the two LAG ports P1b and P1c serving as the choices of the transmission port to the MCLAG1 unlike the case of the frame FL1c.

### General Operation of Relay System (in the Occurrence of Fault at MCLAG port [2])

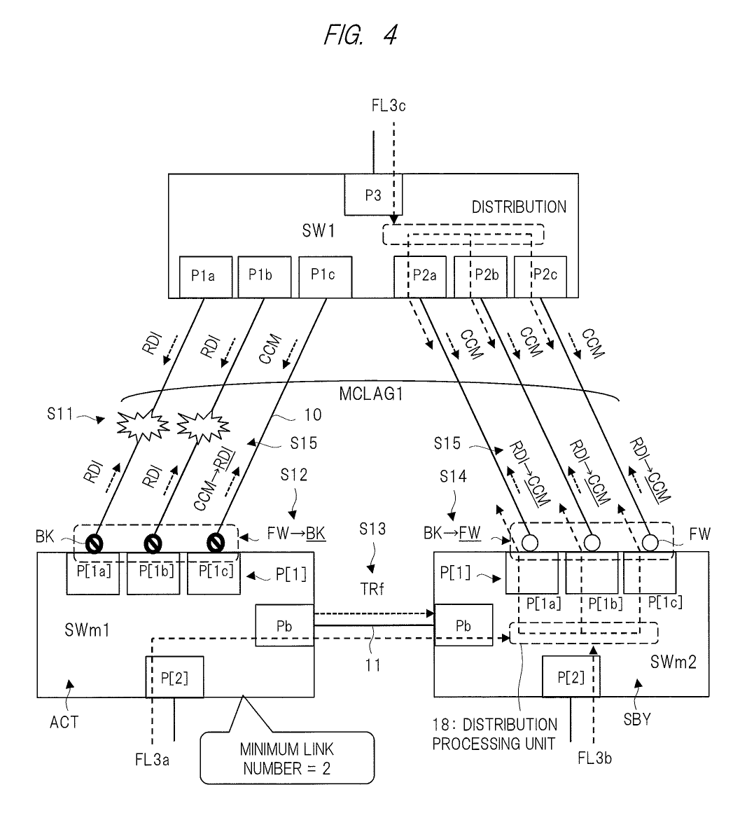

FIG. 4 is an explanatory diagram schematically showing an operation example in the case in which a fault occurs at a MCLAG port and the minimum link number is not satisfied in the relay system of FIG. 1. Here, the case in which a fault further occurs also on the communication line 10 connected to the MCLAG port P[1b] of the L2 switching device SWm1 in the state of FIG. 3 is taken as an example. Also, the minimum link number is set to 2 in this case.

The fault monitoring unit 15 of the L2 switching device SWm1 detects a fault, occurrence at the MCLAG port P[1b] in addition to the fault, occurrence at the MCLAG port P[1a] (step S11). Since the number of MCLAG ports (P[1c]) in which no fault occurrence is detected by the fault monitoring unit 15 in the MCLAG port group P[1] is smaller than the minimum link number (=2), the minimum link determining unit 19 of the L2 switching device SWm1 determines that a link fault is present.

Since it is determined that the link fault is present, the port control unit 14 of the L2 switching device SWm1 controls the plurality of MCLAG ports P[1a], P[1b] and P[1c] constituting the MCLAG port group P[1] to the transmission/reception prohibited state BK instead of the transmission/reception permitted state FW (step S12). Note that the MCLAG ports P[1a] and P[1b] are controlled to the transmission/reception prohibited state BK also by the normal process induced by the fault occurrence. Therefore, the port control unit 14 is characterized by controlling the MCLAG port P[1c], in which no fault occurrence is detected, to the transmission/reception prohibited state BK instead of the transmission/reception permitted state FW.

Since it is determined that a link fault is present, the fault frame transmitting unit 16 of the L2 switching device SWm1 transmits the fault notification frame TRf via the bridge port Pb (step 313). The fault notification frame TRf contains information of the place of fault occurrence (for example, MCLAG identifier {MCLAG1}). The port control unit 14 of the L2 switching device SWm2 receives the fault notification frame TRf. Consequently, the port control unit 14 controls the MCLAG ports P[1a], P[1b] and P[1c], in which no fault occurrence is detected by the fault monitoring unit 15, in the MCLAG port group P[1] in its own switching device corresponding to the place of fault occurrence in the fault notification frame TRf to the transmission/reception permitted state FW instead of the transmission/reception prohibited state BK (step S14).

The OAM transmitting unit 17 of the L2 switching device SWm2 transmits the CCM instead of the RDI at regular intervals from each of the MCLAG ports P[1a], P[1b] and P[1c] controlled to the transmission/reception permitted state FW (step S15). Since the user L2 switching device SW1 receives the CCM at regular intervals at each of the LAG ports P2a, P2b and P2c, it transmits the CCM at regular intervals from each of the LAG ports P2a, P2b and P2c.

On the other hand, the OAM transmitting unit 17 of the L2 switching device SWm1 transmits the RDI from each of the plurality of MCLAG ports P[1a], P[1b] and P[1c] controlled to the transmission/reception prohibited state BK. More specifically, the OAM transmitting unit 17 transmits the RDI instead of the CCM also from the MCLAG port P[1c], in which no fault occurrence is detected, in addition to the MCLAG ports P[1a] and P[1b] in which the fault occurrence is detected (step S15).

Since the L2 switching device SW1 does not receive the CCM control frame at the LAG ports P1a and P1b, it transmits the RDI from the LAG ports P1a and P1b. Also, since the L2 switching device SW1 receives the RDI at the LAG port P1c, it transmits the CCM from the LAG port P1c. As a result, as shown in FIG. 4, the L2 switching device SW1 adds the LAG ports P2a, P2b and P2c to the choices of the transmission port to the MCLAG1 and eliminates the LAG ports P1b and P1c from the choices of the transmission port to the MCLAG1 in addition to the LAG port P1a from the state of FIG. 3.

In this situation, each of the frames FL3a, FL3b and FL3c is transferred through the paths shown in FIG. 4. The transfer paths correspond to those obtained by interchanging the L2 switching device SWm1 and the L2 switching device SWm2 of FIG. 2. Since processes such as the learning and the retrieval on the address table FDB are performed in the same manner as those in the example of FIG. 2, they will be briefly described below.

First, the case in which the L2 switching device SWm1 receives the frame FL3a at the port P[2] is assumed. The L2 switching device SWm1 learns a source MAC address of the frame FL3a in association with the port identifier {P[2]} to the address table FDB, and retrieves a destination port corresponding to a destination MAC address from the address table FDB. As the retrieval result of the destination port, the L2 switching device SWm1 acquires the MCLAG identifier {MCLAG1}. Since its own MCLAG port group P[1] corresponding to the MCLAG identifier {MCLAG1} is controlled to the transmission/reception prohibited state BK, the L2 switching device SWm1 relays the frame FL3a to the bridge port Pb.

The L2 switching device SWm2 learns the source MAC address of the frame FL3a received at the bridge port Pb in association with the port identifier {Pb} to the address table FDB, and retrieves a destination port corresponding to the destination MAC address from the address table FDB. As the retrieval result of the destination port, the L2 switching device SWm2 acquires the MCLAG identifier {MCLAG1}. Since its own MCLAG port group P[1] corresponding to the MCLAG identifier {MCLAG1} is controlled to the transmission/reception permitted state FW, the L2 switching device SWm2 relays the frame FL3a to one MCLAG port (for example, P[1a]) selected based on the predetermined distribution rule. The user L2 switching device SW1 receives the frame FL3a at the predetermined LAG port (for example, P2a) and relays it to the port P3.

Next, the case in which the L2 switching device SWm2 receives the frame FL3b at the port P[2] is assumed. The L2 switching device SWm2 learns a source MAC address of the frame FL3b in association with the port identifier {P[2]} to the address table FDB, and retrieves a destination port corresponding to a destination MAC address from the address table FDB. As the retrieval result of the destination port, the L2 switching device SWm2 acquires the MCLAG identifier {MCLAG1}. Since its own MCLAG port group P[1] corresponding to the MCLAG identifier {MCLAG1} is controlled to the transmission/reception permitted state FW, the L2 switching device SWm2 relays the frame FL3b to one MCLAG port (for example, P[1b]) selected based on the predetermined distribution rule. The user L2 switching device SW1 receives the frame FL3b at the predetermined LAG port (for example, P2b) and relays it to the port P3.

Subsequently, the case in which the user L2 switching device SW1 receives the frame FL3c at the port P3 is assumed. As a result of the retrieval on the address table, the L2 switching device SW1 acquires a LAG identifier corresponding to the MCLAG1 as a destination port corresponding to the destination MAC address of the frame FL3c. The L2 switching device SW1 relays the frame FL3c to one LAG port (for example, P2c) selected from the LAG ports P2a, P2b and P2c serving as choices of the transmission port to the MCLAG1 based on the predetermined distribution rule.

The L2 switching device SWm2 learns the source MAC address of the frame FL3c received at the predetermined MCLAG port (for example, P[1c]) in association with the MCLAG identifier {MCLAG1} to the address table FDB, and retrieves a destination port corresponding to the destination MAC address from the address table FDB. As a result, the L2 switching device SWm2 acquires the port identifier {P[2]} or the port identifier {Pb} as the destination port.

When the port identifier {P[2]} is acquired as the destination port, the L2 switching device SWm2 relays the frame FL3c to the port P[2]. Meanwhile, when the port identifier {Pb} is acquired as the destination port, the L2 switching device SWm2 adds the reception port identifier {MCLAG1} to the frame FL3c and then relays the frame FL3c to the bridge port Pb. The L2 switching device SWm1 learns the source MAC address of the frame FL3c received at the bridge port Pb in association with the reception port identifier {MCLAG1} added to the frame to the address table FDB. Also, the L2 switching device SWm1 retrieves a destination port corresponding to the destination MCA address of the frame FL3c from the address table FDB and relays the frame FL3c to the port P[2] acquired as the destination port.

### General Operation of Relay System (in the Recovery from Fault at MCLAG Port)

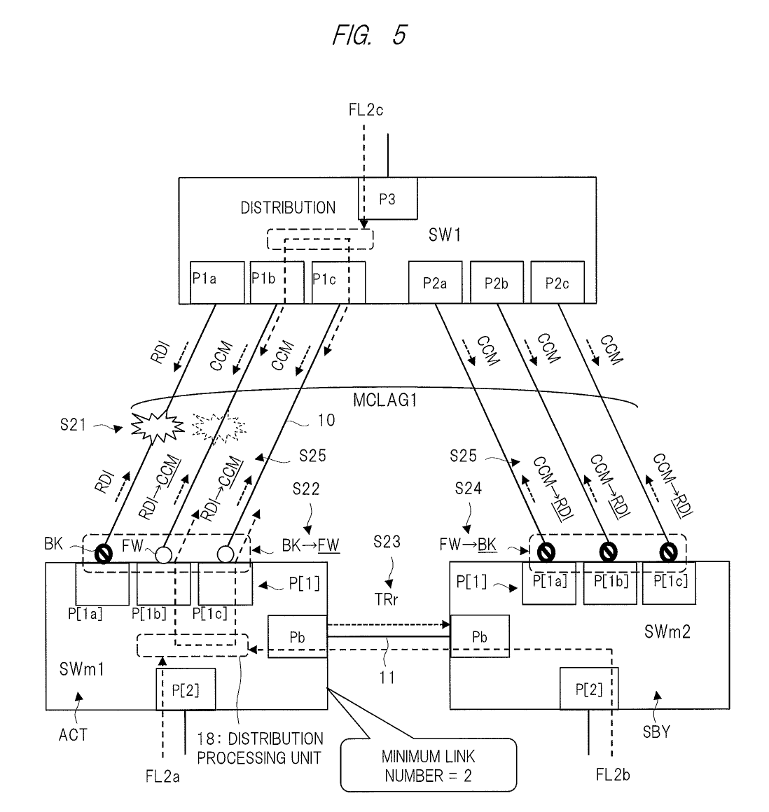

FIG. 5 is an explanatory diagram schematically showing an operation example in the case of recovery from fault at a MCLAG port in the relay system of FIG, 1. Here, the case in which the fault at the MCLAG port P[1b] is recovered from the state shown in FIG. 4 is taken as an example. In FIG. 5, the fault monitoring unit 15 of the L2 switching device SWm1 detects the recovery from fault at the MCLAG port P[1b] (step S21). Since the number of MCLAG ports (P[1b] and P[1c]), in which no fault occurrence is detected by the fault monitoring unit 15, in the MCLAG port group P[1] is equal to or larger than the minimum link number (=2), the minimum link determining unit 19 of the L2 switching device SWm1 determines that a link fault is absent instead of present.

Since it is determined that the link fault is absent, the port control unit 14 of the L2 switching device SWm1 controls the MCLAG ports P[1b] and P[1c], in which no fault occurrence is detected by the fault monitoring unit 15, in the MCLAG port group P[1] to the transmission/reception permitted state FW instead of the transmission/reception prohibited state BK (step 322). Since the determination result by the minimum link determining unit 19 is changed from the presence of link fault to the absence of link fault, the fault frame transmitting unit 16 of the L2 switching device SWm1 transmits a fault recovery frame TRr via the bridge port Pb (step S23). The fault recovery frame TRr contains information of the place of fault recovery (for example, MCLAG identifier {MCLAG1}).

The port control unit 14 of the L2 switching device SWm2 receives the fault recovery frame TRr. Thus, the port control unit 14 controls the plurality of MCLAG ports P[1a], P[1b] and P[1c] constituting the MCLAG port group P[1] of its own switching device corresponding to the place of fault recovery of the fault recovery frame TRr to the transmission/reception prohibited state BK instead of the transmission/reception permitted state FW (step 324).

The OAM transmitting unit 17 of the L2 switching device SWm2 transmits the RDI instead of CCM at regular intervals from each of the plurality of MCLAG ports P[1a], P[1b] and P[1c] controlled to the transmission/reception prohibited state BK like the case of FIG. 3 (step S25). The user L2 switching device SW1 also transmits the CCM at regular intervals from each of the LAG ports P2a, P2b and P2c like the case of FIG. 3.

On the other hand, the OAM transmitting unit 17 of the L2 switching device SWm1 transmits the CCM instead of the RDI at regular intervals from each of the MCLAG ports P[1b] and P[1c] controlled to the transmission/reception permitted state FW (step S25). Since the user L2 switching device SW1 receives the CCM at regular intervals at each of the LAG ports P1b and P1c, it transmits the CCM at regular intervals from each of the LAG ports P1b and P1c.

Also, since the CCM control frame is not received at the MCLAG port P[1a] due to the fault occurrence, the OAM transmitting unit 17 of the L2 switching device SWm1 transmits the RDI from, the MCLAG port P[1a]. Similarly, since the user L2 switching device SW1 also does not receive the CCM control frame at the LAG port P1a due to the fault occurrence, it transmits the RDI from the LAG port P1a. As a result, the user L2 switching device SW1 eliminates the LAG ports P2a, P2b and P2c from the choices of the transmission port to the MCLAG1 and adds the LAG ports P1b and P1c to the choices of the transmission port to the MCLAG1 from the state of FIG. 4.

Thus, the same state as that of FIG. 3 is obtained. As a result, as shown in FIG. 5, the path of each of the frames FL2a, FL2b and FL2c is defined in the same manner as that of the case of FIG. 3. Note that the operation example of automatically returning to the state of FIG. 3 in response to the recovery from fault has been described here, but the operation is not limited to this. For example, it is also possible to employ the method capable of selecting whether to return to the state of FIG. 3.

Specifically, the MCLAG device has an automatic recovery mode and a manual recovery mode that can be selected in advance by an administrator or others. In the automatic recovery mode, the MCLAG device automatically changes the state of each MCLAG port group in response to the recovery from fault as shown in FIG. 5. Also, in the manual recovery mode, the MCLAG device changes the state of each MCLAG port group upon reception of a command input from an administrator or others. In other words, even when the fault is recovered, the MCLAG device maintains the state of each MCLAG port group shown in FIG. 4 until it receives a command input.

For example, when the fault shown in FIG. 4 is an unstable fault, the situation in which the state of FIG. 4 and the state of FIG. 5 are alternately repeated may arise, but this situation can be prevented by selecting the manual recovery mode. Furthermore, in the case of FIG. 5, since the fault is still present though the minimum link number is satisfied, the reduction in communication band may occur, but this situation can be prevented by selecting the manual recovery mode.

### Main Effects of Relay System

As described above, by using the relay system and the switching device of the present embodiment, for example, the following effects can be obtained.

(1) First, the network management can be facilitated. Specifically, in the MCLAG devices, when a frame is monitored by, for example, port mirroring, it is only required to monitor the MCLAG port group set to active ACT (P[1] of SWm1), and it becomes unnecessary to monitor the MCLAG port group set to standby SBY (P[1] of SWm2).

(2) Also, it is possible to solve the problem of insufficient communication band between the MCLAG devices and the user L2 switching device SW1 caused when the MCLAG devices of active/standby type are used. In addition, it is also possible to efficiently improve the availability at the time of occurrence of the fault. For example, the case in which the communication band of 20 Gbps is required between the MCLAG devices and the user L2 switching device and the band of each MCLAG port (P[1a] and others) is 10 Gbps is assumed.

In this case, when no fault is present as shown in FIG. 2, the communication band, of 30 Gbps can be secured, and even when a fault occurs in one communication line 10 as shown in FIG. 3, the communication band of 20 Gbps can be secured. Therefore, since the necessary communication band can be secured while almost maintaining the state of each MCLAG port without the fault notification between the two L2 switching devices constituting the MCLAG devices described with reference to FIG. 4, the latency required for the switching at the time of fault can be reduced.

On the other hand, when the desired communication band cannot be secured by the L2 switching device SWm1 on the active ACT side like the case of FIG. 4, though the latency required for the switching at the time of fault is increased, the desired communication band can be secured by making the L2 switching device SWm2 on the standby SBY side perform the communication with the L2 switching device SW1. In this manner, since the desired communication band can be secured while suppressing the latency required for the switching at the time of fault, the availability can be efficiently improved.

(3) Furthermore, here, by setting each of the MCLAG ports as MEP and using the CCM control frame based on the Ethernet OAM, the user L2 switching device SW1 performs the operation in accordance with the control state of each MCLAG port of the MCLAG devices. Typically, as shown in FIG. 2 and others, by transmitting the RDI from a predetermined MCLAG port, the user L2 switching device SW1 stops the transmission of the frame from the corresponding LAG port. In this manner, by using the Ethernet OAM, the user L2 switching device SW1 can perform the appropriate operations in accordance with various situations by using the CCM and RDI properly as shown in FIG. 3 to FIG. 5 while securing the availability of the user L2 switching device SW1.

Note that, in the technique of the Patent Document 1, network devices are both used in an active state for a data plane, and there is no distinction between active and standby for ports like the present embodiment. Also, the technique of the Patent Document 2 is the technique of controlling the path by defining the actions relative to the combinations of a source address and a destination address based on the MPLS network, and it is essentially different from the system of the present embodiment. Furthermore, the technique of the Patent Document 3 does not use the LAG. In this case, as described above, there is a threat that, the flushing of the FDB needs to be performed when a fault occurs.

### Configuration of Switching Device (MCLAG Device)

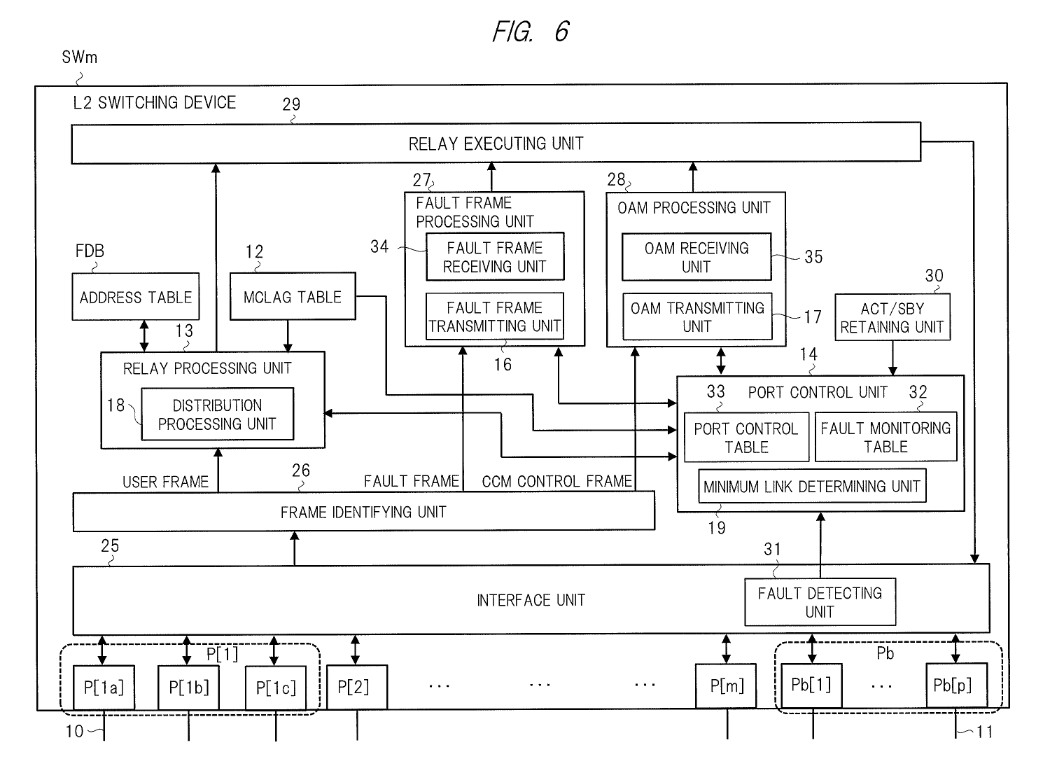

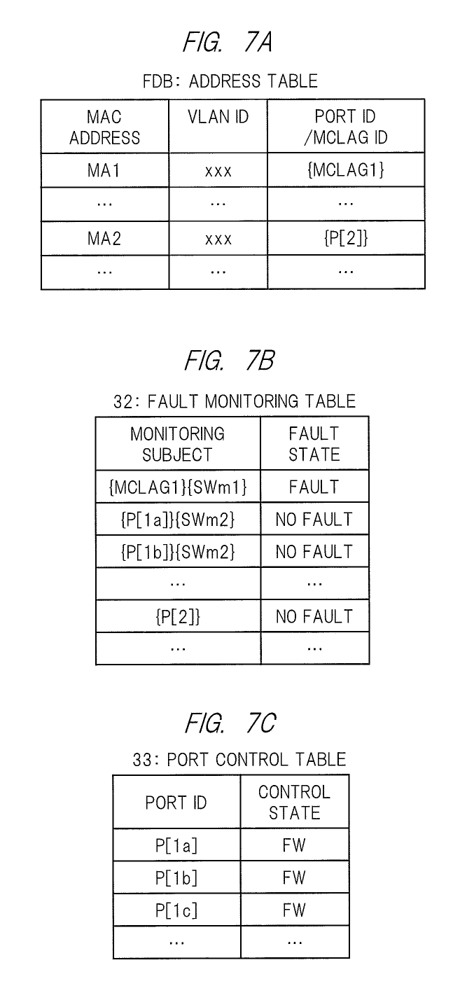

FIG. 6 is a block diagram of a configuration example of the principle part of the L2 switching device constituting the MCLAG device in the relay system of FIG. 1. FIG. 7A is a schematic diagram of a configuration example of the address table of FIG. 6, FIG. 7B is a schematic diagram of a configuration example of a fault monitoring table of FIG. 6, and FIG. 7C is a schematic diagram of a configuration example of a port control table of FIG. 6.

The L2 switching device (first or second switching device) SWm shown in FIG. 6 includes a MCLAG port group (first port group) P[1], a plurality of ports P[2] to P[m], the bridge port Pb, various processing units, and various tables. The MCLAG port group P[1] is made up of a plurality of (in this case, three) MCLAG ports P[1a], P[1b] and P[1c]. In this example, the bridge port Pb is made up of a plurality of bridge ports Pb[1] to Pb[p]. The plurality of bridge ports Pb[1] to Pb[p] function as virtually one port by setting the LAG thereon. Each of the plurality of ports P[2] to P[m] may be the MCLAG port group like the case of P[1]. Hereinafter, various processing units and tables will be described.

An interface unit 25 has a reception buffer and a transmission buffer, and transmits and receives a frame to and from each of the ports (MCLAG ports P[1a], P[1b] and P[1c],the plurality of ports P[2] to P[m] and the bridge port Pb). When receiving a frame at a port, the interface unit 25 adds a port identifier representing the port having received the frame (i.e., reception port identifier) to the frame. Also, the interface unit 25 has a fault detecting unit 31. The fault detecting unit 31 takes a part of the function of the fault monitoring unit 15 described with reference to FIG. 1 and others. The fault detecting unit 31 detects the fault occurrence at each port (P[1a] to P[1c], P[2] to P[m] and Pb[1] to Pb[p]) with the use of hardware such as a detection circuit of the signal intensity of the received signal and a detection circuit of a pulse signal such as FLP. The information of the detected, fault is reflected on a fault monitoring table 32 provided in the port control unit 14.

A frame identifying unit 26 identifies whether the frame received at each port (P[1a] to P[1c], P[2] to P[m] and Pb[1] to Pb[p]) and transmitted through the reception buffer of the interface unit 25 is a user frame, a fault frame or a CCM control frame. The user frame means, for example, an ordinary frame such as the frame FL1a shown in FIG. 2. The fault frame means, for example, the fault notification frame TRf shown in FIG. 4 and the fault recovery frame TRr shown in FIG. 5. The CCM control frame means, for example, the CCM and RDI based on the Ethernet OAM as described above.

Though not particularly limited, the frame identifying unit 26 identifies the user frame, the fault frame and the CCM control frame based on frame type and a destination MAC address (for example, destined for MCLAG device or not) contained in the frame. When the frame is identified as a user frame, the frame identifying unit 26 transmits the user frame to the relay processing unit 13. Also, when the frame is identified as a fault frame, the frame identifying unit 26 transmits the fault frame to a fault frame processing unit 27. Further, when the frame is identified as a CCM control frame, the frame identifying unit 26 transmits the CCM control frame to an OAM processing unit 28.

The fault frame processing unit 27 includes a fault frame receiving unit 34 and a fault frame transmitting unit 16. The fault frame receiving unit 34 detects the fault occurrence and the recovery from fault in a MCLAG port group of another L2 switching device (in this specification, referred to as peer device) connected to the bridge port Pb and constituting the MCLAG device together with its own switching device based on the fault frame from the peer device. The information of the detected fault is reflected on the fault monitoring table 32 provided in the port control unit 14.

The OAM processing unit 28 includes an OAM receiving unit 35 and an OAM transmitting unit 17 and performs various processes based on the Ethernet OAM. As one of the processes, the OAM processing unit 28 monitors the continuity between each MEP by transmitting and receiving a CCM control frame at regular intervals between the MEP set in advance. The OAM receiving unit 35 detects the fault occurrence and recovery from fault at each of the ports based on the reception state of the CCM control frame from the user L2 switching device connected to the MCLAG ports P[1a], P[1b] and P[1c] and the plurality of ports P[2] to P[m].

Specifically, the OAM receiving unit 35 detects the fault occurrence at the port based on non-reception of the CCM control frame at a certain port within a predetermined period. Also, the OAM receiving unit 35 detects the fault occurrence at the port based on reception of the RDI at a certain port. The information of the detected fault is reflected on the fault monitoring table 32 provided in the port control unit 14. The OAM receiving unit 35 takes another part of the function of the fault monitoring unit 15 described with reference to FIG. 1 and others together with the above-mentioned fault detecting unit 31.

An ACT/SBY retaining unit 30 retains setting information of active ACT or standby SBY in units of device (or in units of MCLAG port group) determined in advance by the administrator, etc. The MCLAG table 12 retains the MCLAG ports P[1a], P[1b] and P[1c] of its own switching device in association with a MCLAG identifier {MCLAG1} as shown in FIG. 1.

The port control unit 14 controls the state of each MCLAG port group based on the information of the MCLAG table 12, the information of the fault frame receiving unit 34, the information of the OAM receiving unit 35, the information of the fault detecting unit 31 and the information of the ACT/SBY retaining unit 30 as described with reference to FIG. 1 to FIG. 5. Specifically, the port control unit 14 includes the minimum link determining unit 19, the fault monitoring table 32 and a port control table 33.

The fault monitoring table 32 retains the fault state (for example, presence and absence of fault) of each port (for example, MCLAG port P[1a]) of its own switching device (for example, SWm2) and the fault state of the MCLAG port group of the peer device (SWm1) as shown in FIG. 7B. The MCLAG port group of the peer device (SWm1) is identified by using, for example, the MCLAG identifier {MCLAG1} thereof. The fault state of each port of its own switching device is determined by the detection result of the fault detecting unit 31 and the OAM receiving unit 35 corresponding to the fault monitoring unit 15 of FIG. 1. The fault state of the MCLAG port group of the peer device is determined by the fault frame receiving unit 34.

The minimum link determining unit 19 determines that a link fault is absent when the number of MCLAG ports, in which no fault occurrence is detected, in the MCLAG port group (for example, P[1]) of its own switching device is equal to or larger than the minimum link number and determines that a link fault is present when the number is smaller than the minimum link number based on the fault monitoring table 32 and the MCLAG table 12.

The port control unit 14 controls the state of the MCLAG port of its own switching device based on the determination result of the minimum link determining unit 19, the information of the fault monitoring table 32 and the information of the ACT/SBY retaining unit 30, and manages the control state on the port control table 33. In the port control table 33 of FIG. 7C (and the fault monitoring table 32 of FIG. 7B), the L2 switching device SWm2 of FIG. 4 is taken as an example, and the MCLAG ports P[1a], P[1b] and P[1c] thereof are controlled to the transmission/reception permitted state FW.

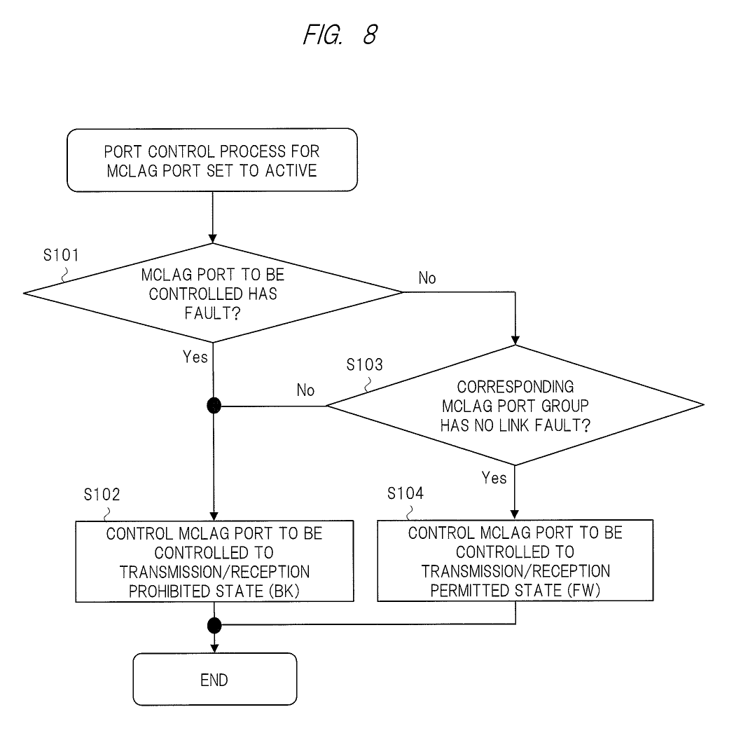

FIG. 8 is a flowchart schematically showing an example of process contents carried out by the port control unit of the L2 switching device of FIG. 6 when the L2 switching device is set to active. In FIG. 8, the port control unit 14 determines whether a MCLAG port to be controlled has a fault based on the fault monitoring table 32 (step S101). When the MCLAG port to be controlled has a fault, the port control unit 14 controls the MCLAG port to the transmission/reception prohibited state BK (step S102).

Also, when the MCLAG port to be controlled has no fault, the port control unit 14 determines whether it is determined that a link fault is absent in the MCLAG port group corresponding to the MCLAG port (step S103). When it is determined that a link fault is absent, the port control unit 14 controls the MCLAG port to be controlled to the transmission/reception permitted state FW (step S104). Meanwhile, when it is determined that a link fault is present, the port control unit 14 controls the MCLAG port to the transmission/reception prohibited state BK (step S102).

For example, in the case of the L2 switching device SWm1 of FIG. 3, the MCLAG ports to be controlled are P[1a], P[1b] and P[1c]. Since the MCLAG port P[1a] has a fault, the port control unit 14 controls the MCLAG port P[1a] to the transmission/reception prohibited state BK (step S102). Also, since the MCLAG ports P[1b] and P[1c] have no fault and the minimum link determining unit 19 determines that a link fault is absent in the MCLAG port group P[1], the port control unit 14 controls the MCLAG ports P[1b] and P[1c] to the transmission/reception permitted state FW (step S104).

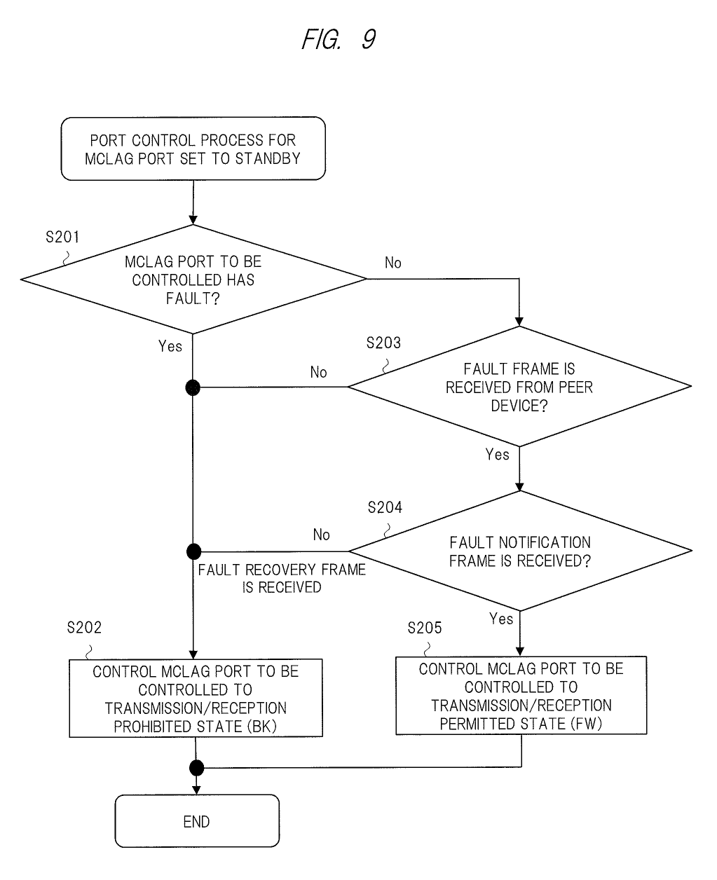

FIG. 9 is a flowchart schematically showing an example of process contents carried out by the port control unit of the L2 switching device of FIG. 6 when the L2 switching device is set to standby. In FIG. 9, the port control unit 14 determines whether a MCLAG port to be controlled has a fault based on the fault monitoring table 32 (step S201). When the MCLAG port to be controlled has a fault, the port control unit 14 controls the MCLAG port to the transmission/reception prohibited state BK (step S202).

Also, when the MCLAG port to be controlled has no fault, the port control unit 14 determines whether a fault frame (fault notification frame or fault recovery frame) is received from a peer device (step 3203). When the fault frame is not received, the port control unit 14 controls the MCLAG port to be controlled to the transmission/reception prohibited state BK (step S202). Meanwhile, when a fault notification frame is received as the fault frame, the port control unit 14 controls the MCLAG port to be controlled to the transmission/reception permitted, state FW (step S205), and when a fault recovery frame is received as the fault frame, the port control unit 14 controls the MCLAG port to be controlled to the transmission/reception prohibited state BK (step S202). Specifically, the port control unit 14 determines the fault occurrence and the recovery from fault in the MCLAG port group of the peer device corresponding to the MCLAG port to be controlled with reference to the fault monitoring table 32 upon reception of the fault frame.

For example, in the case of the L2 switching device SWm2 of FIG. 4, the MCLAG ports to be controlled are P[1a], P[1b] and P[1c]. Since the MCLAG port P[1a] has no fault and the fault notification frame TRf is received, the port control unit 14 controls the MCLAG port P[1a] to the transmission/reception permitted state FW (step S205). Similarly, the port control unit 14 performs the process of FIG. 9 for each of the MCLAG ports P[1b] and P[1c], and as a result, it controls the MCLAG ports P[1b] and P[1c] to the transmission/reception permitted state FW (step S205).

Note that, if only the MCLAG port P[1a] has a fault in the MCLAG ports P[1a], P[1b] and P[1c] of the L2 switching device SWm2, the MCLAG port P[1a] is controlled to the transmission/reception prohibited state BK (step S202). Also, though omitted in FIG. 9, when the determination result by its own minimum link determining unit 19 is the presence of link fault, the port control unit 14 on a standby side controls the MCLAG ports P[1a], P[1b] and P[1c] to the transmission/reception prohibited state BK even if the fault notification frame is received.

In FIG. 6, when the minimum link determining unit 19 determines that a link fault is present, the fault frame transmitting unit 16 of the fault frame processing unit 27 generates the fault notification frame TRf containing the information of the place of fault occurrence. Also, when the determination result by the minimum link determining unit 19 is changed from the presence of link fault to the absence of link fault, the fault frame transmitting unit 16 generates the fault recovery frame TRr containing the information of the place of fault recovery. For example, the fault frame transmitting unit 16 adds a destination port identifier {Pb} representing the destination port to the generated fault frame and then transmits the fault frame to a relay executing unit 29.

The OAM transmitting unit 17 of the OAM processing unit 28 transmits the CCM at regular intervals from each of the MCLAG ports controlled to the transmission/reception permitted state FW based on the port control table 33 and the fault monitoring table 32. Also, the OAM transmitting unit 17 transmits the RDI at regular intervals from each of the plurality of MCLAG ports controlled to the transmission/reception prohibited state BK based on the port control table 33. At this time, in the example of FIG. 6, the OAM transmitting unit 17 adds a port identifier of the corresponding MCLAG port as the destination port identifier to each of the generated CCM control frames, and transmits the CCM control frame to the relay executing unit 29.

Note that the OAM processing unit 23 can monitor the continuity of a normal port (for example, P[2]) and the bridge port Pb based on the CCM control frame, in addition to that of the MCLAG port. At this time, the OAM processing unit 28 performs the process in conformity to the standard of the Ethernet OAM unlike the case of the MCLAG port.

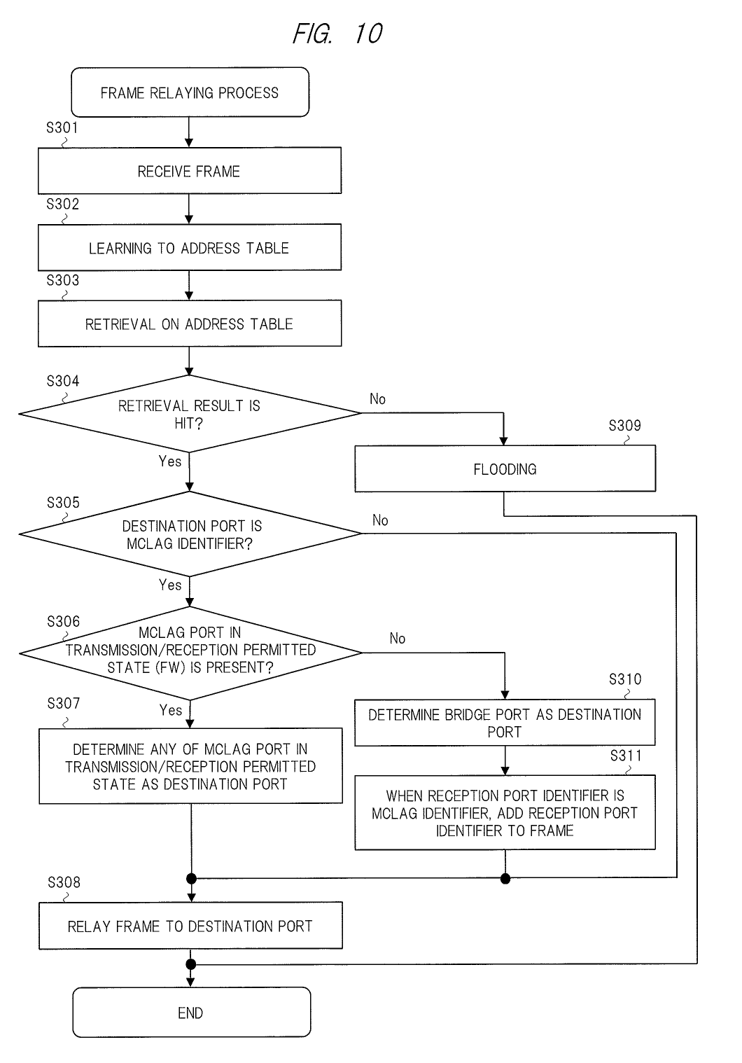

The relay processing unit 13 includes the distribution processing unit 18, The relay processing unit 13 performs the learning and retrieval on the address table FDB for the user frame from the frame identifying unit 26 as described with reference to FIG. 1 to FIG. 5, and determines the destination port in view of the information of the port control unit 14 (specifically, port control table 33). FIG. 10 is a flowchart schematically showing an example of process contents carried out by the relay processing unit of the L2 switching device of FIG. 6. In FIG. 10, the relay processing unit 13 receives a frame (user frame) from the frame identifying unit 26 (step S301) and learns the source MAC address thereof in association with the reception port identifier to the address table FDB (step S302).

The reception port identifier is added to the frame by the interface unit 25 as described above. However, when the reception port identifier is the port identifier (for example, {P[1a]}) of the MCLAG port based on the. MCLAG table 12, the relay processing unit 13 replaces the reception port identifier with the MCLAG identifier ({MCLAG1}) corresponding to the MCLAG port and then learns it to the address table FDB. Furthermore, as described with reference to FIG. 1 and others, when the frame to which the reception port identifier has already been added, is received at the bridge port Pb, the relay processing unit 13 learns the source MAC address contained in the frame in association with the reception port identifier to the address table FDB.

As a result, the address table FDB retains the correspondence relation between a port and a MAC address present ahead of the port as shown in FIG. 7A. In FIG. 7A, the port is retained as the port identifier thereof (for example, {P[2]}) or the MCLAG identifier (for example, {MCLAG1}). Note that the address table FDB actually retains a VLAM (Virtual Local Area Network) identifier in addition to the MAC address.

Next, the relay processing unit 13 performs the retrieval on the address table FDB with using the destination MAC address (and VLAN identifier) of the frame as a retrieval key, thereby acquiring the destination port (step S303). When the retrieval result is hit (step S304), the relay processing unit 13 determines whether the destination port is a MCLAG identifier (step 3305). When the destination port is a MCLAG identifier, the relay processing unit 13 determines whether the MCLAG port controlled to the transmission/reception permitted state FW is present in the MCLAG port group of its own switching device corresponding to the destination MCLAG identifier based on the information of the port control unit 14 (specifically, the port control table 33) (step S306).

When the MCLAG port in the transmission/reception permitted state FW is present, the relay processing unit 13 determines one MCLAG port as the destination port from the MCLAG ports in the transmission/reception permitted state FW by using the distribution processing unit 18 (step S307). At this time, though not particularly limited, the distribution processing unit 18 determines one MCLAG port (for example, P[1a]) by a hash operation using the source MAC address and the destination MAC address of the frame. Then, the relay processing unit 13 relays the frame to the destination port (step S308). Specifically, the relay processing unit 13 adds the destination port identifier (for example, {P[1a]} to the frame and transmits the frame to the relay executing unit 29.

On the other hand, when the MCLAG port in the transmission/reception permitted state FW is not present in the step S306 (namely, when the MCLAG port group is controlled to the transmission/reception prohibited state BK), the relay processing unit 13 determines the bridge port Pb as the destination port (step S310). Furthermore, when the reception port identifier is the MCLAG identifier, the relay processing unit 13 adds the reception port identifier (MCLAG identifier) to the frame (step S311). Then, the relay processing unit 13 relays the frame to which the reception port identifier is added to the destination port (step S308). Specifically, the relay processing unit 13 further adds the destination port identifier {Pb} to the frame and transmits the frame to the relay executing unit 29.

Also, when the retrieval result, of the address table FDB is mishit in the step S304, the relay processing unit 13 floods the frame in a VLAN to which the frame belongs (step S309). For example, the case in which the retrieval result with respect to the frame FL1a in the L2 switching device SWm1 is mishit in FIG. 2 is assumed. In this case, the relay processing unit 13 of the L2 switching device SWm1 determines the ports (P[1] and Pb) other than the port P[2] (i.e., the port having received the frame FL1a) to be the candidates for flooding,

Here, since the MCLAG port group P[1] is in the transmission/reception permitted state FW, the relay processing unit 13 floods the frame FL1a to the MCLAG port group P[1] (actually, one of the MCLAG ports P[1a], P[1b] and P[1c]) and the bridge port Pb. Meanwhile, when the retrieval result is mishit, the replay processing unit 13 of the L2 switching device SWm2 which has received the frame FL1a at the bridge port Pb determines the ports (P[1] and P[2]) other than the port (Pb) having received the frame FL1a to be the candidates for flooding. However, since the MCLAG port group P[1] is in the transmission/reception prohibited state BK, the relay processing unit 13 floods the frame FL1a to the port P[2].

Also, the case in which the retrieval result with respect to the frame FL1c in the L2 switching device SWm1 is mishit in FIG. 2 is assumed. In this case, the relay processing unit 13 of the L2 switching device SWm1 floods the frame FL1c to the ports (P[2] and Pb) other than the MCLAG port group P[1]. When the retrieval result is mishit, the replay processing unit 13 of the L2 switching device SWm2 which has received the frame FL1c at the bridge port Pb determines the ports (P[1] and P[2]) other than the port (Pb) having received the frame FL1c to be the candidates for flooding. However, since the MCLAG port group P[1] is in the transmission/reception prohibited state BK, the relay processing unit 13 floods the frame FL1c to the port P[2].

As described above, one of the two MCLAG port groups constituting the MCLAG is controlled to the transmission/reception prohibited state BK in the present embodiment. Therefore, the looping back and duplicate transmission of frames in the MCLAG do not occur. However, in order to enhance the reliability, the looping back may be prevented based on the reception port identifier added to the frame received at the bridge port Pb. For example, the relay processing unit 13 of the L2 switching device SWm2 which has received the frame FL1c at the bridge port Pb prevents the flooding to the MCLAG port group P[1] based on the reception port identifier ({MCLAG1}) added to the frame FL1c.

Also, when the destination port is not the MCLAG identifier in the step S305 of FIG. 10, the relay processing unit 13 relays the frame to the destination port acquired from the retrieval result on the address table FDB (step 3308). Specifically, the relay processing unit 13 adds the destination port identifier representing the destination port to the frame and transmits the frame to the relay executing unit 29.

The relay executing unit 29 transmits the user frame from the relay processing unit 13, the fault frame from the fault frame processing unit 27 or the CCM control frame from the OAM processing unit 28 to a predetermined transmission buffer in the interface unit 25. The predetermined transmission buffer is the buffer corresponding to the destination port identifier added to the frame. The transmission buffer in the interface unit 25 receives the frame from the relay executing unit 29 and transmits the frame to the corresponding port.

### General Configuration of User 12 Switching Device

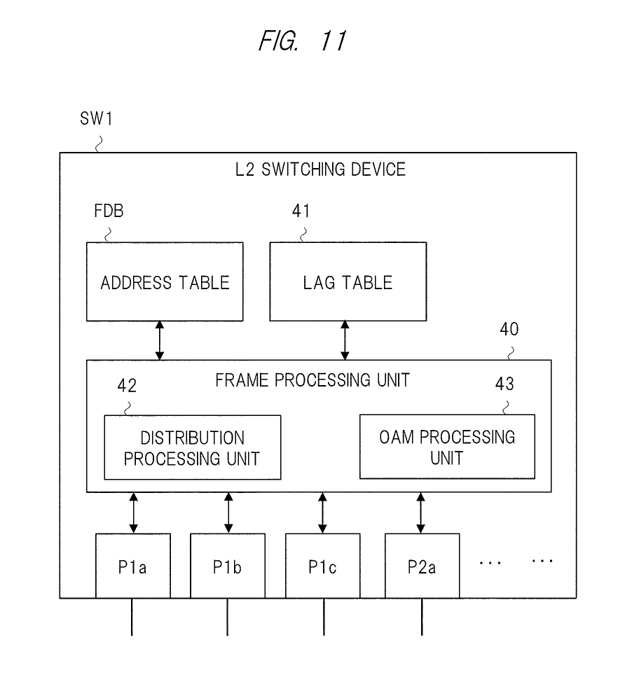

FIG. 11 is a block diagram schematically showing a configuration example of the user L2 switching device in the relay system of FIG. 1. The L2 switching device (third switching device) SW1 shown in FIG. 11 includes LAG ports P1a, P1b, P1c, P2a, . . . , a frame processing unit 40, an address table FDB and a LAG table 41. As shown in FIG. 1, the LAG ports P1a, P1b and P1c are connected to the MCLAG ports P[1a], P[1b] and P[1c] of the L2 switching device SWm1, respectively, via the communication lines 10. Similarly, the LAG ports P2a, P2b and P2c (illustrations of P2b and P2c are omitted) are connected to the MCLAG ports of the L2 switching device SWm2, respectively.

The address table FDB retains the correspondence relation between a port (actually, port identifier or LAG identifier), a MAC address present ahead of the port and a VLAN identifier like the case of FIG. 7A. The LAG table 41 retains the correspondence relation between the LAG identifier and the port identifiers of member ports of the LAG identifier like the case of the MCLAG table 12 of FIG. 1. For example, the LAG table 41 retains the correspondence relation between the LAG identifier {LAG1} corresponding to the MCLAG1 and the port identifiers {P1a}, {P1b}, {P1c}, {P2a}, {P2b} and {P2c} of the member ports thereof.

When a frame is received at a predetermined port, the frame processing unit 40 performs learning and retrieval on the address table FDB with reference to the LAG table 41, and relays the frame to the destination port based on the retrieval result. Also, the frame processing unit 40 includes the distribution processing unit 42 and the OAM processing unit 43. As shown in FIG. 2 to FIG. 5, the OAM processing unit 43 transmits and receives the CCM frame (CCM, RDI) between MEP set in advance based on the normal standard of the Ethernet OAM, thereby monitoring the presence and absence of fault at the LAG port.

As shown in FIG. 2 to FIG. 5, when relaying a frame to the LAG identifier {LAG1}, the distribution processing unit 42 selects one LAG port from the choices of the transmission port corresponding to all or a part of the member ports thereof based on the predetermined distribution rule. The choices of the transmission port are LAG ports determined to have no fault by the OAM processing unit 43 (namely, LAG ports receiving the CCM).

In the foregoing, the invention made by the inventors of the present invention has been concretely described based on the embodiments. However, it is needless to say that the present invention is not limited to the foregoing embodiments and various modifications and alterations can be made within the scope of the present invention. For example, the embodiments above have been described in detail so as to make the present invention easily understood, and the present invention is not limited to the embodiment having all of the described constituent elements. Also, a part of the configuration of one embodiment may be replaced with the configuration of another embodiment, and the configuration of one embodiment may be added to the configuration of another embodiment. Furthermore, another configuration may be added to a part of the configuration of each embodiment, and a part of the configuration of each embodiment may be eliminated or replaced with another configuration.

For example, the port control unit 14 controls the state (FW or BK) in units of MCLAG port as shown by the port control table 33 of FIG. 7C and others, but it can control the state in units of MCLAG port group in some cases. In this case, the relay processing unit 13 selects the transmission port based on the state of the MCLAG port group and the reference result of the fault monitoring table 32, thereby indirectly determining whether or not transmission at each of MCLAG ports constituting the MCLAG port group is possible. Also, the OAM transmitting unit 17 controls the CCM and RDI at each of the MCLAG ports based on the control state of the MCLAG port group and the reference result of the fault monitoring table 32, thereby indirectly determining whether or not reception at each of MCLAG ports is possible.

What is claimed is:

1. A relay system comprising:
a first switching device and a second switching device each having a first port group made up of a plurality of first ports and a bridge port, the first switching device and the second switching device being connected to each other by a communication line via the bridge ports; and
a third switching device connected to the plurality of first ports of the first switching device and the plurality of first ports of the second switching device via different communication lines, the third switching device setting a link aggregation group on ports serving as connection sources of the communication lines,
wherein the first port group of the first switching device is set to active and the first port group of the second switching device is set to standby,
each of the first switching device and the second switching device includes:
a fault monitoring unit which detects a fault occurrence at the plurality of first ports;
a minimum link determining unit which determines that a link fault is absent when the number of the first ports, in which no fault occurrence is detected by the fault monitoring unit, in the first port group is equal to or larger than a predetermined set number, and determines that a link fault is present when the number is smaller than the set number;
a fault frame transmitting unit which transmits a fault notification frame via the bridge port when the minimum link determining unit determines that the link fault is present; and
a port control unit and an OAM transmitting unit,
in a first case in which the first port group is set to the active and when the minimum link determining unit determines that the link fault is absent, the port control unit controls the first port, in which no fault occurrence is detected by the fault monitoring unit, in the first port group to a first state in which transmission and reception are both permitted, and in the first case and when the minimum link determining unit determines that the link fault is present, the port control unit controls the plurality of first ports constituting the first port group to a second state in which transmission and reception are both prohibited,
in a second case in which the first port group is set to the standby and when the fault notification frame is not received via the bridge port, the port control unit controls the plurality of first ports constituting the first port group to the second state, and in the second case and when the fault notification frame is received via the bridge port, the port control unit controls the first port, in which no fault occurrence is detected by the fault monitoring unit, in the first port group to the first state, and
the OAM transmitting unit transmits a CCM frame based on Ethernet OAM from each of the first ports controlled to the first state, and transmits a RDI frame based on Ethernet OAM from each of the first ports controlled to the second state.

2. The relay system according to claim 1,
wherein each of the first switching device and the second switching device further includes:
a MCLAG table which, retains the plurality of first ports in association with first identifiers; and
a relay processing unit which, when the first port controlled to the first state is present in the first port group, relays a frame containing the first identifier as a destination port to any of the first port controlled to the first state, and when the first port controlled to the first state is not present in the first port group, relays a frame containing the first identifier as a destination port to the bridge port.

3. The relay system according to claim 1,
wherein, when a determination result by the minimum. link determining unit is changed from presence of the link fault to absence of the link fault, the fault frame transmitting unit transmits a fault recovery frame via the bridge port, and
in the second case and when the fault recovery frame is received via the bridge port, the port control unit controls the plurality of first ports constituting the first port group to the second state.

4. A switching device having a first port group made up of a plurality of first ports and a bridge port and connected to a different switching device via the bridge port, the switching device comprising:
a fault monitoring unit which detects a fault occurrence at the plurality of first ports;
a minimum link determining unit which determines that a link fault is absent when the number of the first ports, in which no fault occurrence is detected by the fault monitoring unit, in the first port group is equal to or larger than a predetermined set number, and determines that a link fault is present when the number is smaller than the set number;
a fault frame transmitting unit which transmits a fault notification frame via the bridge port when the minimum link determining unit determines that the link fault is present; and
a port control unit and an OAM transmitting unit,
wherein, in a first case in which the first port group is set to active and when the minimum link determining unit determines that the link fault is absent, the port, control unit controls the first port, in which no fault occurrence is detected by the fault monitoring unit, in the first port group to a first state in which transmission and reception are both permitted, and in the first case and when the minimum link determining unit determines that the link fault is present, the port control unit controls the plurality of first ports constituting the first port group to a second state in which transmission and reception are both prohibited,
in a second case in which the first port group is set to standby and when the fault notification frame is not received via the bridge port, the port control unit controls the plurality of first ports constituting the first port group to the second state, and in the second case and when the fault notification frame is received via the bridge port, the port control unit controls the first port, in which no fault occurrence is detected by the fault monitoring unit, in the first port group to the first state, and
the OAM transmitting unit transmits a CCM frame based on Ethernet OAM from each of the first ports controlled to the first state, and transmits a RDI frame based on Ethernet OAM from each of the first ports controlled to the second state.

5. The switching device according to claim 4, further comprising:
a MCLAG table which retains the plurality of first ports in association with first identifiers; and
a relay processing unit which, when the first port controlled to the first state is present in the first port group, relays a frame containing the first identifier as a destination port to any of the first port controlled to the first state, and when the first port controlled to the first state is not present in the first port group, relays a frame containing the first identifier as a destination port to the bridge port.

6. The switching device according to claim 4,
wherein, when a determination result by the minimum link determining unit is changed from presence of the link fault to absence of the link fault, the fault frame transmitting unit transmits a fault recovery frame via the bridge port, and
in the second case and when the fault recovery frame is received via the bridge port, the port control unit controls the plurality of first ports constituting the first port group to the second state.
